(19) United States
(12) Patent Application Publication
(10) Pub. No.: US 2015/0000066 A1
(43) Pub. Date: Jan. 1, 2015

(54) WIPER DEVICE WITH AT LEAST TWO WIPER BLADE UNITS WHICH ARE CONNECTED BY A SHRINK-FIT CONNECTION

(71) Applicant: Robert Bosch GmbH, Stuttgart (DE)

(72) Inventor: Helmut Depondt, Kessel-Lo (BE)

(21) Appl. No.: 14/365,662

(22) PCT Filed: Dec. 17, 2012
(86) PCT No.: PCT/EP2012/075694

§ 371 Date: Jun. 16, 2014

(30) Foreign Application Priority Data
Dec. 16, 2011 (DE) 10 2011 088 871.3

(51) Int. Cl. B60S 1/38

(52) U.S. Cl. CPC B60S 1/3877; B60S 1/3855; B60S 2001/3898
USPC 15/250.48; 29/447

(57) ABSTRACT

The invention is based on a wiper device having a first wiper blade unit (10) and at least a second wiper blade unit (12). It is proposed that the first and second wiper blade units (10, 12) be connected by means of a shrink -fit connection and/or expansion connection.

### BACKGROUND OF THE INVENTION

A wiper device having a first wiper blade unit and at least a second wiper blade unit has already been proposed.

### SUMMARY OF THE INVENTION

The invention is based on a wiper device having a first wiper blade unit and at least a second wiper blade unit.

It is proposed that the first and second wiper blade units be connected by means of a shrink-fit connection and/or expansion connection. As a result, the wiper device can be particularly simply designed, and the two wiper blade units can particularly be fixedly connected to one another in a simple and cost effective manner. A “wiper blade unit” particularly refers to a component of a wiper blade, wherein a wiper blade comprises a plurality of wiper blade units that are connected to one another. A “shrink-fit and/or expansion connection” refers particularly to a fixed connection between two components, in particular the two wiper blade units, said connection being formed by a change in size of at least one of the two components, advantageously by means of a thermal impact on the relative component, wherein one of the two components encloses the other component as a result of the change in size or braces against the other component. Hence, a “shrink-fit and or expansion connection” refers to a connection which is not solely contingent on an elastic deformation of at least one of the corresponding components.

It is furthermore proposed that the first wiper blade unit be designed as a two-component element. In so doing, the wiper blade unit can be particularly advantageously designed. By the term “two-component element”, an element is particularly to be understood which is constructed from two different materials, in particular different plastics, which can have different material properties and can be fixedly connected to one another in a manufacturing process, in particular a two-component injection molding process.

It is furthermore proposed that the wiper blade unit comprise a receiving area which has a greater rigidity than a wiper lip region of the wiper blade unit. As a result, the wiper blade unit can be very advantageously designed and be particularly advantageously connected to the second wiper blade unit.

It is furthermore proposed that the first wiper blade unit be designed as a wiper blade rubber. In so doing, the wiper blade unit designed as a wiper blade rubber can be particularly advantageously embodied. By the term “wiper blade rubber”, a component of the wiper blade is particularly to be understood which consists of plastic and, in an operating state of the wiper device, rests on a motor vehicle window pane to be wiped and wipes the same. In this regard, the wiper blade rubber has a wiping area, with which said rubber is in contact with the motor vehicle window pane at least in one region, and a receiving area that is provided for fastening the wiper blade rubber to a remainder of the wiper device.

In addition, it is proposed that the second wiper blade unit is designed as a spring rail. As a result, the wiper blade units of the wiper device can be particularly advantageously connected by means of the shrink-fit connection. By the term “spring rail”, an elongated component consisting of a resilient material, advantageously of a metal, is particularly to be understood. Said resilient material is thereby intended to provide a spring force which is provided in an operating state to press the wiper blade rubber with the wiping region thereof against a curved motor vehicle window pane so that the wiper blade rubber contacts the motor vehicle window pane as completely as possible.

It is furthermore proposed that the second wiper blade unit, which is designed as a spring rail, is inserted in the longitudinal direction into the first wiper blade unit that is designed as a wiper blade rubber. In so doing, the wiper blade units can be particularly easily connected to one another by means of a shrink-fit process.

In addition, it is proposed that the shrink-fit and/or expansion connection is produced by means of a heat treatment. In this way, the shrink-fit and/or expansion connection can be particularly easily produced.

### BRIEF DESCRIPTION OF THE DRAWINGS

FIG. 1 is a schematic sectional view of a wiper device according to the invention.

Further advantages ensue from the following description of the drawing. An exemplary embodiment of the invention is depicted in the drawing. The drawing, the description and the claims contain numerous features in combination. The person skilled in the art will also advantageously consider the features individually and put them together to form further useful combinations.

### DETAILED DESCRIPTION

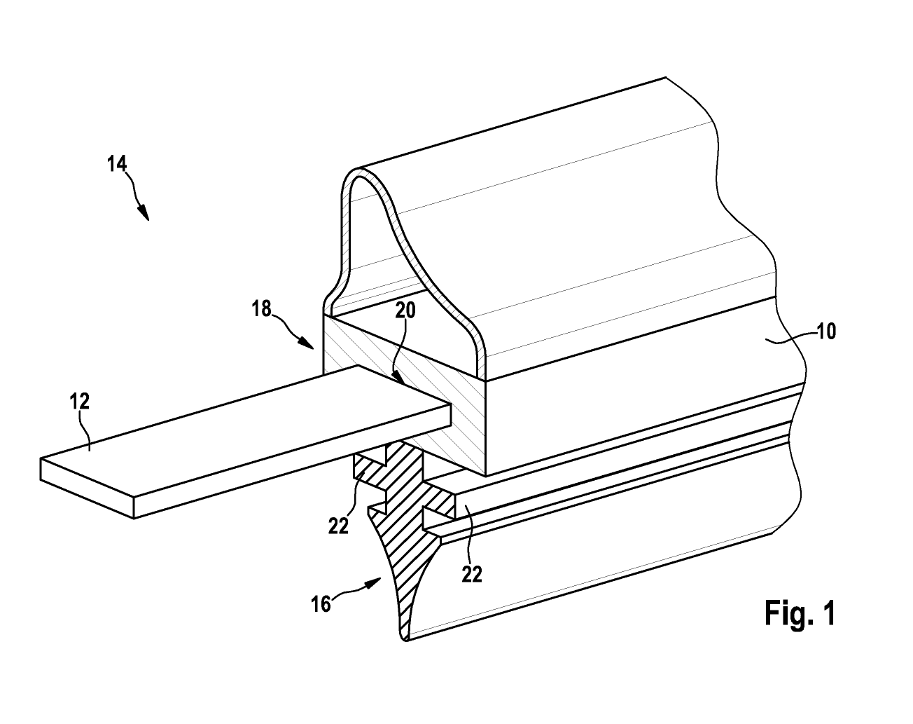

FIG. 1 shows a schematic sectional view of a wiper device according to the invention. The wiper device is part of a wiper system, which is not depicted in detail and which is provided to wipe a curved vehicle window pane of a motor vehicle. To this end, the wiper system comprises a wiper arm, which is not depicted in detail and which is connected to a wiper motor, which is not depicted in detail and which is provided to generate a pivoting movement of the wiper arm. The wiper system comprises a wiper arm adapter which is fixedly connected to the wiper arm, wherein it is also in principle conceivable for the wiper arm to be formed integrally with the wiper arm adapter. The wiper device further comprises a partially depicted wiper blade 14 and a wiper blade adapter which is not depicted in detail and is fixedly connected to the wiper blade 14. The wiper blade adapter can be fixedly and captively connected to the wiper arm adapter in order to mount the wiper blade 14 to the wiper arm.

The wiper device comprises a first wiper blade unit 10 and a second wiper blade unit 12 which at least partially form the wiper blade 14. The wiper device thereby comprises further wiper blade units, which are not depicted in detail and are installed together with the wiper blade units 10, 12 in order to form the wiper blade 14.

The first wiper blade unit 10 is designed as a wiper blade rubber. The first wiper blade unit 10 designed as a wiper blade rubber has an elongated expansion which is oriented along a main extension direction of the entire wiper blade 14. The wiper blade unit 10 designed as a wiper blade rubber comprises a wiper lip region 16. In a completely installed state, the wiper blade unit 10 designed as a wiper blade rubber rests with the wiper lip region 16 thereof against the curved vehicle window pane. The wiper lip region 16 is of arrow-shaped design, a tapered end of the wiper lip region 16 facing the vehicle window pane and resting on the same in the installed state. The wiper lip region 16 of the wiper blade unit 10 that is designed as a wiper blade rubber has two lateral webs 22 on a side facing away from the tapered end, which webs can also rest on the vehicle window pane during a wiping operation in order to more effectively wipe said vehicle window pane. In principle, it is also conceivable that the wiper lip region 16 is designed differently and, for example, has no or more than two lateral webs 22.

The first wiper blade unit 10 designed as a wiper blade rubber further comprises a receiving area 18. The receiving area 18 is disposed on a side of the wiper lip region 16 which, in the installed state, faces away from the vehicle window pane. The wiper lip region 16 and the receiving area 18 are integrally formed with one another and thereby fixedly connected to one another. The receiving area 18 of the wiper blade unit 10 designed as a wiper blade rubber comprises a recess 20 oriented along the elongated expansion of said wiper blade unit 10 designed as a wiper blade rubber, said recess extending from a front end to a rear end of the wiper blade unit 10 designed as a wiper blade rubber. The recess 20 is provided to receive the second wiper blade unit 12 in an installed state.

The first wiper blade unit 10 designed as a wiper blade rubber is formed as a two-component element. In so doing, the wiper lip region 16 consists of a different material than the receiving area 18 of the wiper blade unit 10 designed as a wiper blade rubber. The receiving area 18 as well as the wiper lip region 16 is thereby manufactured from a plastic material. The wiper blade unit 10 designed as a wiper blade rubber is manufactured in a two-component injection molding process, wherein the receiving area 18 and wiper lip region 16 of the wiper blade unit 10 designed as a wiper blade rubber are formed together and are thus fixedly connected to one another. The different plastics of the wiper lip region 16 and the receiving area 18 of the wiper blade unit 10 designed as a wiper blade rubber have different material properties. The receiving area 18 has a greater rigidity than the wiper lip region 16.

The first wiper blade unit 10 and the second wiper blade unit 12 are connected to one another via a shrink-fit connection. The shrink-fit connection is thereby produced by means of a heat treatment. To this end, the second wiper blade unit 12 designed as a spring rail is inserted in the longitudinal direction into the first wiper blade unit 10 that is designed as a wiper blade rubber during a manufacturing process of the wiper blade 14. If the wiper blade unit 12 designed as a spring rail is correctly introduced into the recess 20, the receiving area 18 is heated by means of a suitable method that appears useful to the person skilled in the art. The receiving area 18 shrinks due to the effect of the heat. The recess 20 which is introduced into the receiving area 18 becomes smaller as a result of the shrinking of said receiving area 18. In contrast, the wiper blade unit 12 designed as a spring rail 12 does not shrink. By the reduction in size of the recess 20 in which the wiper blade unit 12 designed as a spring rail is disposed, said wiper blade unit 12 designed as a spring rail is clamped in the receiving area 18. As a result, the wiper blade unit 12 designed as a spring rail is fixedly connected to the wiper blade unit 10 designed as a wiper blade rubber. The wiper blade unit 12 designed as a spring rail can no longer slide out of the wiper blade unit 10 designed as a wiper blade rubber. The shrinkage of the receiving area 18 of the wiper blade unit 10 designed as a wiper blade rubber remains intact after the wiper blade unit 10 has cooled down,

In principle, it is also conceivable that the first wiper blade unit 10 and the second wiper blade unit 12 are connected to one another by means of an expansion connection. In so doing, the second wiper blade unit 12 designed as a spring rail is cooled down and thereby shrunk by means of a method that appears useful to the person skilled in the art before being introduced into the recess 20 of the receiving area 18. The shrunken second wiper blade unit 12 that is designed as a spring rail is introduced into the recess 20 of the receiving area 18 and fixed in a desired position. In the process, the second wiper blade unit 12 designed as a spring rail fits free of play into the recess 20 of the receiving area 18. By means of a heating process, the wiper blade unit 12 designed as a spring rail again assumes the original form thereof and expands again in the recess 20. The wiper blade unit 12 designed as a spring rail is thereby clamped in the recess 20 of the receiving area 18 of the first wiper blade unit 10 designed as a spring rail. As a result, the wiper blade unit 12 designed as a spring rail is fixedly connected to the wiper blade unit 10 designed as a wiper blade rubber.

1. A wiper device having a first wiper blade unit (10) and at least a second wiper blade unit (12), characterized in that the first and the second wiper blade unit (10, 12) are connected by at least one of a shrink-fit connection and an expansion connection.

2. The wiper device according to claim 1, characterized in that the first wiper blade unit (10) is a two-component element.

3. The wiper device according to claim 1, characterized in that the wiper blade unit (10) comprises a receiving area (18) which has a greater rigidity than a wiper lip region (16) of the wiper blade unit (10).

4. The wiper device according to claim 1, characterized in that the first wiper blade unit (10) is a wiper blade rubber.

5. The wiper device according to claim 1, characterized in that the second wiper blade unit (12) is a spring rail.

6. The wiper device according to claim 5, characterized in that the spring rail is inserted in a longitudinal direction into the wiper blade rubber.

7. The wiper device according to claim 1, characterized in that the at least one of a shrink-fit and an expansion connection is produced by means of a heat treatment.

8. A wiper blade comprising a wiper device according to claim 1.

9. (canceled)

10. The wiper device according to claim 1 wherein the first and the second wiper blade unit (10, 12) are connected by an expansion connection.

11. The wiper device according to claim 10 wherein the first and the second wiper blade unit (10, 12) are connected by a shrink-fit connection.

12. The wiper device according to claim 1 wherein the first and the second wiper blade unit (10, 12) are connected by a shrink-fit connection.

13. A method for manufacturing a wiper device having a first wiper blade unit (10) and at least a second wiper blade unit (12), the method comprising connecting the first and the second wiper blade unit (10, 12) by at least one of a shrink-fit connection and an expansion connection.

14. The method according to claim 13, characterized in that the first wiper blade unit (10) is a two-component element.

15. The method according to claim 13, characterized in that the wiper blade unit (10) comprises a receiving area (18) which has a greater rigidity than a wiper lip region (16) of the wiper blade unit (10).

16. The method according to claim 13, characterized in that the first wiper blade unit (10) is a wiper blade rubber.

17. The method according to claim 13, characterized in that the second wiper blade unit (12) is a spring rail.

18. The method according to claim 17, characterized in that the spring rail is inserted in a longitudinal direction into the wiper blade rubber.

19. The method according to claim 13, characterized in that the at least one of a shrink-fit and an expansion connection is produced by means of a heat treatment.
